(19) United States
(12) Patent Application Publication
(10) Pub. No.: US 2018/0157675 A1
(43) Pub. Date: Jun. 7, 2018

(54) SYSTEM AND METHOD FOR CREATING ENTITY PROFILES BASED ON MULTIMEDIA CONTENT ELEMENT SIGNATURES

(71) Applicant: Cortica, Ltd., Tel Aviv (IL)

(72) Inventors: Igal Raichelgauz, New York, NY (US); Karina Odinaev, New York, NY (US); Yehoshua Y Zeevi, Haifa (IL)

(73) Assignee: Cortica, Ltd., TEL AVIV (IL)

(21) Appl. No.: 15/802,890

(22) Filed: Nov. 3, 2017

Related U.S. Application Data
(63) Continuation-in-part of application No. 15/296,551, filed on Oct. 18, 2016.
Application No. 15/296,551 is a continuation-in-part of application No. 14/643,694, filed on Mar. 10, 2015, now Pat. No. 9,672,217.
Application No. 14/643,694 is a continuation of application No. 13/766,463, filed on Feb. 13, 2013, now Pat. No. 9,031,999.
Application No. 13/766,463 is a continuation-in-part of application No. 13/602,858, filed on Sep. 4, 2012, now Pat. No. 8,868,619.
Application No. 13/602,858 is a continuation of application No. 12/603,123, filed on Oct. 21, 2009, now Pat. No. 8,266,185.
Application No. 12/603,123 is a continuation-in-part of application No. 12/084,150, filed on Apr. 7, 2009, now Pat. No. 8,655,801.
Application No. 12/603,123 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 12/603,123 is a continuation-in-part of application No. 12/348,888, filed on Jan. 5, 2009, now Pat. No. 9,798,795.
Application No. 12/348,888 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 12/603,123 is a continuation-in-part of application No. 12/538,495, filed on Aug. 10, 2009, now Pat. No. 8,312,031.
Application No. 12/538,495 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/195,863 is a continuation-in-part of application No. 12/348,888, filed on Jan. 5, 2009, now Pat. No. 9,798,795.
(60) Provisional application No. 62/417,824, filed on Nov. 4, 2016.
(60) Provisional application No. 62/310,742, filed on Mar. 20, 2016.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/30

(52) U.S. Cl. CPC G06F 17/30156; Y10S 707/99943; G06F 17/30321; G06F 17/30598; Y10S 707/99948; G06F 17/3002; G06F 17/30023

(57) ABSTRACT

A system and method for creating a profile for an entity. The method includes crawling through at least one web source, wherein the crawling includes identifying at least one multimedia content element (MMCE) associated with a search query in the at least one web source; analyzing the at least one MMCE, wherein the analyzing further includes generating at least one signature based on the at least one MMCE; identifying, based on the generated at least one signature, an entity associated with the at least one MMCE; determining at least one characteristic associated with the entity; and generating a profile for the entity based on the at least one characteristic.

### CROSS-REFERENCE TO RELATED APPLICATIONS

This application claims the benefit of U.S. Provisional Application No. 62/417,824 filed on Nov. 4, 2016, the contents of which are hereby incorporated by reference. This application is also a continuation-in-part of U.S. patent application Ser. No. 15/296,551 filed on Oct. 18, 2016, now pending, which claims the benefit of U.S. Provisional Patent Application No. 62/310,742 filed on Mar. 20, 2016. The Ser. No. 15/296,551 application is also a continuation-in-part of U.S. patent application Ser. No. 14/643,694 filed on Mar. 10, 2015, now U.S. Pat. No. 9,672,217, which is a continuation of U.S. patent application Ser. No. 13/766,463 filed on Feb. 13, 2013, now U.S. Pat. No. 9,031,999. The Ser. No. 13/766,463 application is a continuation-in-part of U.S. patent application Ser. No. 13/602,858 filed on Sep. 4, 2012, now U.S. Pat. No. 8,868,619. The Ser. No. 13/602,858 application is a continuation of U.S. patent application Ser. No. 12/603,123 filed on Oct. 21, 2009, now U.S. Pat. No. 8,266,185. The Ser. No. 12/603,123 application is a continuation-in-part of:

(1) U.S. patent application Ser. No. 12/084,150 having a filing date of Apr. 7, 2009, now U.S. Pat. No. 8,655,801, which is the National Stage of International Application No. PCT/IL2006/001235, filed on Oct. 26, 2006, which claims foreign priority from Israeli Application No. 171577 filed on Oct. 26, 2005, and Israeli Application No. 173409 filed on Jan. 29, 2006;

(2) U.S. patent application Ser. No. 12/195,863 filed on Aug. 21, 2008, now U.S. Pat. No. 8,326,775, which claims priority under 35 USC 119 from Israeli Application No. 185414, filed on Aug. 21, 2007, and which is also a continuation-in-part of the above-referenced U.S. patent application Ser. No. 12/084,150;

(3) U.S. patent application Ser. No. 12/348,888 filed on Jan. 5, 2009, now pending, which is a continuation-in-part of the above-referenced U.S. patent application Ser. Nos. 12/084,150 and 12/195,863; and

(4) U.S. patent application Ser. No. 12/538,495 filed on Aug. 10, 2009, now U.S. Pat. No. 8,312,031, which is a continuation-in-part of the above-referenced U.S. patent application Ser. Nos. 12/084,150; 12/195,863; and Ser. No. 12/348,888.

All of the applications referenced above are herein incorporated by reference.

### TECHNICAL FIELD

The present disclosure relates generally to the analysis of multimedia content, and more specifically to generating a profile based on an analysis of multimedia content elements.

### BACKGROUND

As the amount of content available over the Internet continues to grow exponentially in size, the task of identifying relevant content has become increasingly cumbersome. Identifying relevant content can be particularly important for corporations and advertisers who wish to monitor the use of certain brands on the Internet and world-wide web, including within images and other multimedia content elements uploaded to and shared on social media networks.

The online impression of a brand is of utmost importance, and may spur a newfound success in assisting a company to build a social media presence as consumers become acquainted with the brand and products or services associated therewith. Conversely, a negative association with a brand, such as through a shared image, video, or post, can equally spread and become viral, hurting the entities associated with the shared content.

Accordingly, there is a need for an effective method of monitoring such multimedia content. Searching, organizing and management of multimedia content can be challenging due to the difficulty involved in interpreting and comparing the information embedded within the multimedia content.

Moreover, when it is necessary to find multimedia content by means of a textual query, some existing solutions revert to various metadata that textually describe the multimedia content. However, such content may be abstract and complex by nature and not adequately defined by the existing and/or attached metadata.

A difficulty arises in cases where the target multimedia content is not adequately defined in words, or otherwise adequately described by metadata associated with the multimedia data. For example, it may be desirable to locate a particular model of a specific car model in a large database of images or video clips or segments. In some cases, the model name of the car would be part of the metadata, but in many cases, it would not. Moreover, the various images of the car may be taken from angles that differ from the angles of a reference photograph of the car that is provided with the query.

Searching multimedia content has been a challenge for a number of years and has therefore received considerable attention. Early systems would take a multimedia data element in the form of, for example, an image, compute various visual features from it and then search one or more indexes to return images with similar features. In addition, values for these features and appropriate weights reflecting their relative importance could be also used. These methods have improved over time to handle various types of multimedia inputs and to handle them in an ever-increasing effectiveness. However, because of the exponential growth of the use of the Internet, the multimedia data available from these systems have become less effective in handling the currently available multimedia data due to the vast amounts already existing as well as the speed at which new data is created and added.

Searching through multimedia data for specific features, such as a brand name of logo, has therefore become a significant challenge, where even the addition of metadata to assist in the search has limited functionality. A query model for a search engine has some advantages, such as comparison and ranking of images based on objective visual features, rather than on subjective image annotations. However, the query model has its drawbacks as well. When no metadata is available and only the multimedia data itself can be used, the process requires significant effort.

Additionally, user opinions and impressions of entities and brands have become significantly important due to the increased use of web-based platforms. These opinions and impressions may impact the success of the entity or brand. For example, a news story portraying a company in a negative light that goes viral and is shared frequently on social media may result in noticeable harm to the company's reputation. However, due to the abundance of data existing on the Internet, it has become difficult to tack, monitor, and identify content related to a specific entity or brand. Without accurate tracking or monitoring, a single piece of content (e.g., an article or video) can go viral without appropriate corrective measures, thereby hurting the related entities.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “an embodiment” may be used herein to refer to a single embodiment or multiple embodiments of the disclosure.

Certain embodiments disclosed herein include a method for creating a profile for an entity. The method comprises: crawling through at least one web source, wherein the crawling includes identifying at least one multimedia content element (MMCE) associated with a search query in the at least one web source; analyzing the at least one MMCE, wherein the analyzing further includes generating at least one signature based on the at least one MMCE; identifying, based on the generated at least one signature, an entity associated with the at least one MMCE; determining at least one characteristic associated with the entity; and generating a profile for the entity based on the at least one characteristic.

Certain embodiments disclosed herein also include a non-transitory computer readable medium having stored thereon instructions for causing one or more processing units to execute a process for creating a profile for an entity, the process comprising: crawling through at least one web source, wherein the crawling includes identifying at least one multimedia content element (MMCE) associated with a search query in the at least one web source; analyzing the at least one MMCE, wherein the analyzing further includes generating at least one signature based on the at least one MMCE; identifying, based on the generated at least one signature, an entity associated with the at least one MMCE; determining at least one characteristic associated with the entity; and generating a profile for the entity based on the at least one characteristic.

Certain embodiments disclosed herein also include a system for generation of a profile for an entity. The system comprises: a processing circuitry; and a memory, the memory containing instructions that, when executed by the processing circuitry, configure the system to: crawl through at least one web source, wherein the crawling includes identifying at least one multimedia content element (MMCE) associated with a search query in the at least one web source; analyze the at least one MMCE, wherein the analyzing further includes generating at least one signature based on the at least one MMCE; identify, based on the generated at least one signature, an entity associated with the at least one MMCE; determine at least one characteristic associated with the entity; and generate a profile for the entity based on the at least one characteristic.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a flowchart illustrating a method for generating a profile based on an analysis of multimedia content elements according to an embodiment.

FIG. 3 is a flowchart illustrating a method for analyzing a multimedia content element according to an embodiment.

FIG. 4 is a block diagram depicting the basic flow of information in the signature generator system.

FIG. 5 is a diagram showing the flow of patches generation, response vector generation, and signature generation in a large-scale speech-to-text system.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for creating entity profiles based on analysis of multimedia content. In some embodiments, a method includes accessing a network to identify input multimedia content elements, analyzing the input multimedia content elements to generate signatures based on the content, comparing the generated signatures to previously generated signatures to find one or more matching previously generated signatures, and creating a profile based on the matching previously generated signatures, where the profile includes at least one characteristic. If a profile already exists, a new characteristic is added to the profile based on the input multimedia content elements.

It should be noted that a profile may further be associated with a certain brand, company, or other entity or group of entities. As a non-limiting example, in a case where a certain logo associated with a brand is shown in images of people wearing white scrubs, it is determined that the brand is connected to the medical field, which can be included in its profile.

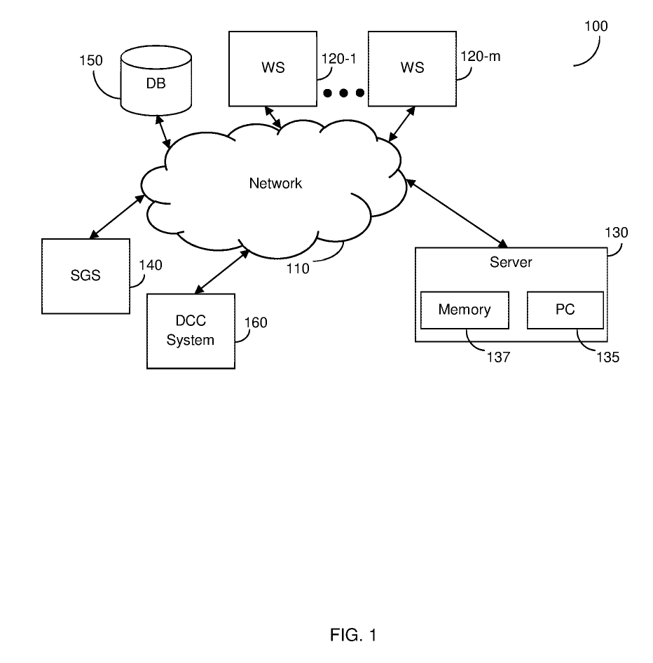

FIG. 1 shows a network diagram 100 utilized to describe the various disclosed embodiments. A plurality of web sources 120-1 through 120-m, a server 130, a signature generator system (SGS) 140, a database 150, and a deep content classifier (DCC) system 160 are communicatively connected via a network 110. The network 110 may include the Internet, the world-wide-web (WWW), a local area network (LAN), a wide area network (WAN), a metro area network (MAN), and other networks capable of enabling communication between elements of a system 100.

The web sources 120-1 through 120-m (hereinafter referred to collectively as web sources 120 merely for simplicity) are connected to the network 110, where ‘m’ is an integer equal to or greater than 1. The web sources 120 include data sources or files available over, for example, the Internet. To this end, the web source 120 may include, but are not limited to, websites, web-pages, social network platforms, search engines, public and private databases and the like. The web sources 120 include one or more multimedia content elements (MMCEs), such as, but not limited to, an image, a photograph, a graphic, a screenshot, a video stream, a video clip, a video frame, an audio stream, an audio clip, combinations thereof, portions thereof, and the like.

A server 130 is connected to the network 110 and is configured to communicate with the web sources 120 and to crawl therethrough. Crawling includes accessing and identifying various data and MMCEs within the web sources 120 and analyzing them as further described herein.

The server 130 may include a processing circuitry (PC) 135 and a memory 137. The processing circuitry 135 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

In an embodiment, the memory 137 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 135 to perform the various processes described herein. Specifically, the instructions, when executed, cause the processing circuitry 135 to create user profiles by analyzing multimedia content, as discussed further herein below.

The database 150 is configured to store MMCEs, signatures generated based on MMCEs, profiles that have been previously generated based on signatures, or a combination thereof. The database 150 is accessible by the server 130, either via the network 110 (as shown in FIG. 1) or directly (not shown).

The SGS 140 and the DCC system 160 are utilized by the server 130 to perform the various disclosed embodiments. The SGS 140 and the DCC system 160 may be connected to the server 130 directly (not shown) or through the network 110 (as shown in FIG. 1). In certain configurations, the DCC system 160 and the SGS 140 may be embedded in the server 130. In an embodiment, the server 130 is connected to or includes an array of computational cores configured as discussed in more detail below.

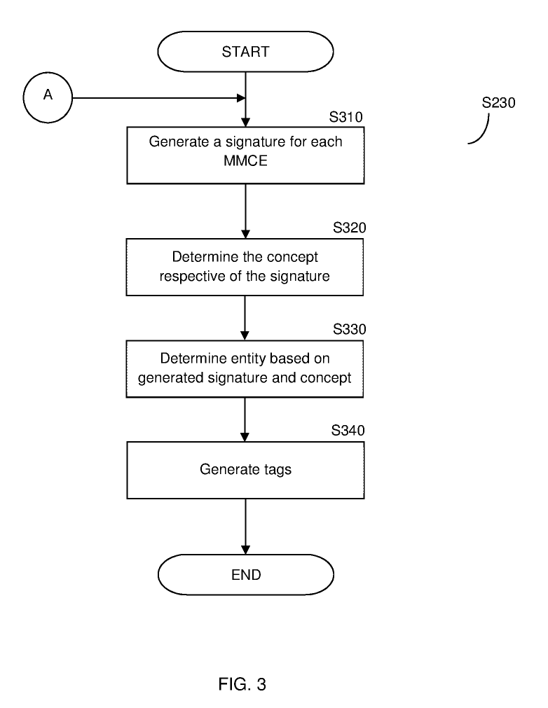

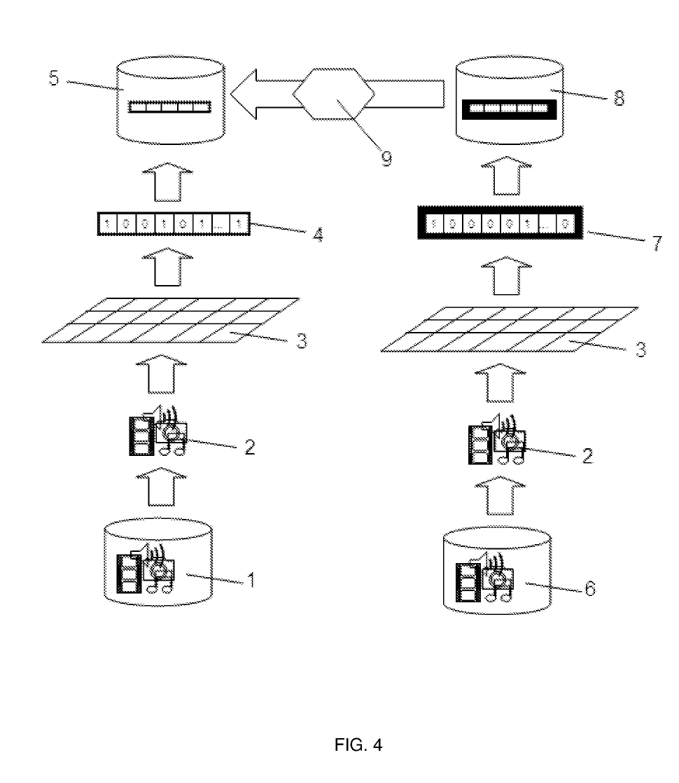

In an embodiment, the server 130 is configured to access at least one input MMCE from the web sources 120 and to send the input MMCE to the SGS 140, the DCC system 160, or both. The decision of which to be used (the SGS 140, the DCC system 160, or both) may be a default configuration or may depend on the circumstances of the particular MMCE being analyzed, e.g., the file type, the web source being accessed, and the like. In an embodiment, the SGS 140 receives the input MMCEs and returns signatures generated thereto. The generated signature(s) may be robust to noise and distortion as discussed regarding FIGS. 3 and 4 below.

According to another embodiment, the analysis of each input MMCE may further be based on a concept structure (hereinafter referred to as a “concept”) determined for the input MMCE. A concept is a collection of signatures representing elements of the unstructured data and metadata describing the concept. As a non-limiting example, a ‘Superman concept’ is a signature-reduced cluster of signatures describing elements (such as MMCEs) related to, e.g., a Superman cartoon: and a set of metadata providing a textual representation of the Superman concept. Techniques for generating concept structures are also described in the above-referenced U.S. Pat. No. 8,266,185 to Raichelgauz et al., the contents of which are hereby incorporated by reference.

According to this embodiment, a query is sent to the DCC system 160 to match an input MMCE to at least one concept. The identification of a concept matching the input MMCE includes matching signatures generated for the input MMCE (such signature(s) may be produced either by the SGS 140 or the DCC system 160) and comparing the generated signatures to reference signatures representing predetermined concepts. The signatures to which the input MMCE is compared may be stored in and accessed from the database 150. The matching can be performed across all concepts maintained by the system DCC 160.

Then, based on the generated signatures, the server 130 is configured to identify at least one entity shown, indicated, mentioned, or otherwise represented by at least a portion of the signatures generated for the input MMCEs. The entity may be, for example, a person, an animal, a brand, a company, a term, a group (e.g., a community, members of a field, etc.), a fictional character, and so on. Based on the identified entity, the server 130 is configured to search for additional MMCEs associated with that entity. In an embodiment, when initiating the search, at least one tag is generated based on the generated signatures. The tag is a textual index term describing the concept that may be used as a search query. The search may include searching through one or more of the web sources 120, content stored within the database 150, both, other data sources (not shown), and the like.

Based on the matching signatures and MMCEs, one or more characteristics associated with the entity are generated. The characteristics may include, for example, impressions associated with the entity, personal variables, themes found to be common among the additional MMCEs and the input MMCE, descriptive phrases, a combination thereof, and the like.

Based on the generated characteristics, a profile associated with the entity is generated or updated by the server 130. The generated or updated profile may be sent by the server 130 to the database 150 for storage therein.

It should be appreciated that generating signatures allows for more accurate analysis of MMCEs in comparison to, for example, relying on metadata. The signatures generated for the MMCEs allow for recognition and classification of MMCEs such as content-tracking, video filtering, multimedia taxonomy generation, video fingerprinting, speech-to-text, audio classification, element recognition, video/image search and any other application requiring content-based signatures generation and matching for large content volumes such as, web and other large-scale databases. For example, a signature generated by the SGS 140 for a picture showing a car enables accurate recognition of the model of the car from any angle at which the picture was taken.

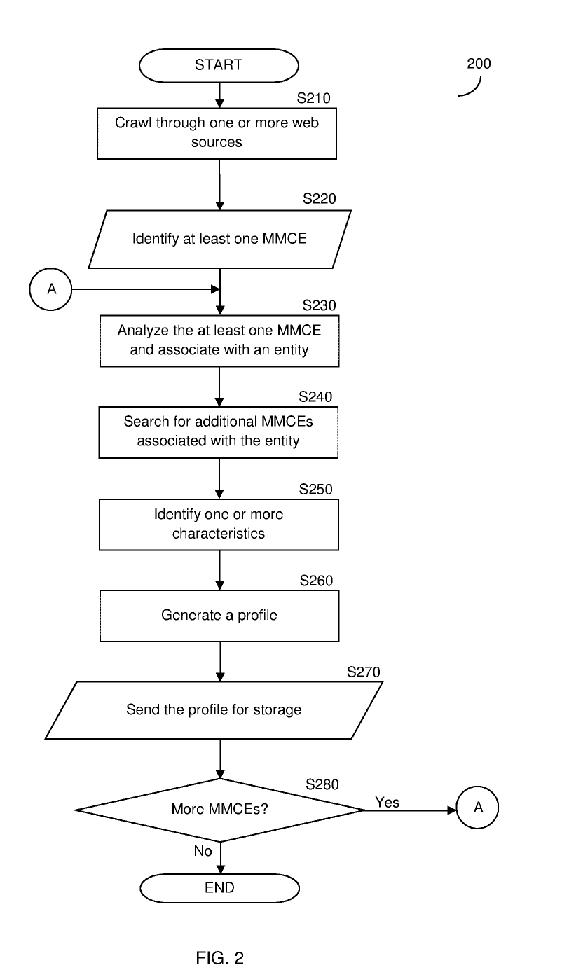

FIG. 2 is a flowchart 200 illustrating a method for creating a profile for an entity based on an analysis of multimedia content elements according to an embodiment.

At S210, one or more web sources are crawled through to search for MMCEs. According to an embodiment, the crawling may be initiated in response to a request received by a web source operator or owner. According to a further embodiment, the crawling may be initiated in response to a request received from a user via a user device. The user device may be, for example, a personal computer (PC), a personal digital assistant (PDA), a mobile phone, a smart phone, a tablet computer, an electronic wearable device (e.g., glasses, a watch, etc.), a smart television and other kinds of wired and mobile appliances.

At S220, based on the crawling, one or more input MMCEs is identified in the web sources. In an embodiment where a crawling is initiated via a request from a user device, the input MMCEs are identified based on the request.

In an example implementation, if the request is a textual query, the text used for the query may be compared to text associated with MMCEs within the web sources that match the text. As a non-limiting example, if the query includes the phrase “food,” MMCEs in the web sources having metadata including “food” are identified.

In another example implementation, the identification may include generating a signature for the request (e.g., by generating a signature for text of the request), and comparing the generated signature to predetermined signatures associated MMCEs stored in the web sources, e.g., signatures previously generated from other MMCEs associated with food and stored. The signatures may be generated by a signature generator system or a deep content classification system, as described further herein below. The predetermined signatures associated with the MMCEs in the web sources may be generated based on, for example, the stored MMCEs, metadata associated with the stored MMCEs, both, and the like.

The web sources may include websites, web-pages, social network platforms, search engines, public and private databases, and the like. The MMCEs may be, but are not limited to, images, photographs, graphics, screenshots, video streams, video clips, video frames, audio streams, audio clips, combinations thereof, portions thereof, and the like.

At S230, each input MMCE is analyzed in order to identify an entity associated with the input MMCE. An entity may include a person, an animal, a brand, a company, a term, a group, and so on. For example, the analysis may include identifying the brand Coca-Cola® when viewing an image of a person holding a bottle of a Coca-Cola® beverage.

Referring now to FIG. 3, there is shown a flowchart S230 describing the process of identifying an entity based on an input MMCE according to an embodiment.

At S310, a signature is generated based on each MMCE accessed from the web sources. In an embodiment, the signature is generated by a signature generation system or a deep-content classification system, which may generate a signature for an MMCE via a large number of independent computational cores.

At S320, a concept is generated based on each generated signature. Concepts are numeric sequences representative of a certain collection of signatures, and may be robust to noise and distortion. The concepts are generated by a process of inter-matching of the signatures once it is determined that there is a number of elements therein above a predefined threshold. That threshold needs to be large enough to enable proper and meaningful clustering.

Each concept is a collection of signatures representing multimedia data elements and metadata describing the concept, and acts as an abstract description of the content to which the signature was generated. As a non-limiting example, a ‘Superman concept’ is a signature-reduced cluster of signatures representing elements (such as MMCEs) related to, e.g., a Superman cartoon, and a set of metadata including a textual representation of the Superman concept. As another example, metadata of a concept represented by the signature generated for a picture showing a bouquet of red roses is “flowers.” As yet another example, metadata of a concept represented by the signature generated for a picture showing a bouquet of wilted roses is “wilted flowers”.

At S330, an entity within the MMCE is determined based on the generated signature and concept. In an embodiment, the signature, the concept, or both, are compared to signatures or concepts stored in a storage, e.g., a database, where the signatures or concepts are previously associated with an entity. For example, if signatures of MMCEs containing a beverage bottle having a red and white label are associated with the Coca-Cola®brand, and those signatures are determined to match the identified MMCE, the determined entity within the MMCE will be Coca-Cola®.

At optional S340, one or more tags is generated for each analyzed MMCE based on the corresponding signature, concept, or both, of the MMCE. Each tag may include one or more textual index terms that may be used for searching purposes, and may be a descriptive phrase or word representing an entity identified in the MMCE. For example, the tag may include the phrase “Coca Cola” or “Sprite” when associated with an MMCE of a person holding or drinking a bottle of the Coca-Cola company's Sprite® soda.

In an embodiment, when the tag is generated based on a concept, the tag may include metadata of the concept. In another embodiment, when the tag is generated based on a signature, the tag may be generated by matching the signature to previously generated signatures associated with reference textual content. The generated tags may include text of textual content having predetermined signatures that match the signature of the MMCE above a predetermined threshold.

Returning to FIG. 2, at S240, based on the analysis, a search is performed for one or more additional MMCEs associated with the identified entity where the additional MMCEs are further analyzed for matching traits. The search may be performed using, for example, the generated tags, signatures representing the concepts of the input MMCE, and the like. Continuing with the aforementioned example, if the determined entity is Coca-Cola®, a search for MMCEs on the web sources that are associated with Coca-Cola® is performed.

At S250, one or more characteristics associated with the entity are determined based on the analysis. The characteristics may include, for example, personal preferences, variables associated with the entity, impressions, positive or negative values (e.g., helpful or boring), themes or associations found to be common among the additional MMCEs and the identified MMCE, descriptive phrases, a combination thereof, and the like. In an embodiment, the characteristics associated with the entity are identified based on the web sources. For example, MMCEs determined to have an association with the entity Coca-Cola® are analyzed to determine characteristics, e.g., impressions or positive or negative values from a web source, such as a social media platform. As a non-limiting example, if a social media post having an MMCE associated with Coca-Cola® and containing a predetermined threshold of “likes” from various users associated with a particular ground, e.g., athletes, it may be determined that athletes or related categories, such as athletic or sports, is a characteristic of that entity.

At S260, a profile is generated for the entity based on the analysis. The profile includes characteristics associated with the entity.

At optional S270, the generated profile is sent for storage in a database. In an embodiment, it is checked if a matching profile exists for the entity, e.g., in a database. If such a profile does exist for the same entity, any additional characteristics extracted from the MMCE may be added to the profile.

At S280, it is checked if additional MMCEs have been received, and if so, execution continues with S230; otherwise, execution terminates.

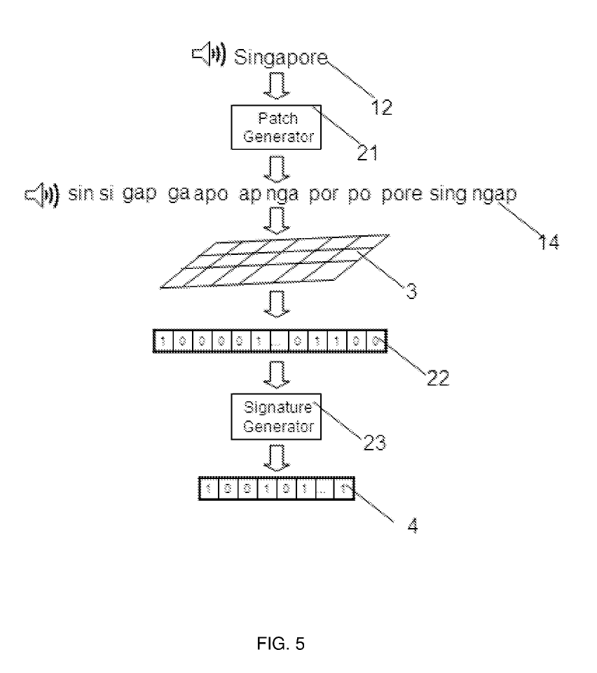

FIGS. 4 and 5 illustrate the generation of signatures for the multimedia content elements by the SGS 120 according to one embodiment. An exemplary high-level description of the process for large scale matching is depicted in FIG. 4. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below.

The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of the signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames. In an embodiment, the signature generator 120 is configured with a plurality of computational cores to perform matching between signatures.

The Signatures' generation process is now described with reference to FIG. 5. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the server 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame T is injected into all the Cores 3. Then, Cores 3 generate two binary response vectors: one which is a Signature vector, and one which is a Robust Signature vector.

For generation of signatures robust to additive noise, such as White-Gaussian-Noise, scratch, etc., but not robust to distortions, such as crop, shift and rotation, etc., a core Ci={nᵢ} (1≤i≤L) may consist of a single leaky integrate-to-threshold unit (LTU) node or more nodes. The node nᵢ equations are:

$${V}_{i} = {\sum }_{j} {w}_{ij} {k}_{j}$$

$${n}_{i} = θ ( Vi - {Th}_{X} )$$

where, θ is a Heaviside step function; wᵢⱼ is a coupling node unit (CNU) between node i and image component j (for example, grayscale value of a certain pixel j); kⱼ is an image component ‘j’ (for example, grayscale value of a certain pixel j); Thx is a constant Threshold value, where ‘x’ is ‘S’ for Signature and ‘RS’ for Robust Signature; and Vi is a Coupling Node Value.

The Threshold values Thx are set differently for Signature generation and for Robust Signature generation. For example, for a certain distribution of Vᵢ values (for the set of nodes), the thresholds for Signature (Th_{S}) and Robust Signature (Th_{RS}) are set apart, after optimization, according to at least one or more of the following criteria:
1: For:

Vᵢ>Th_{RS}

1−p(V>Th_{S})−1−(1−ε)^{l}<<1

i.e., given that I nodes (cores) constitute a Robust Signature of a certain image I, the probability that not all of these I nodes will belong to the Signature of same, but noisy image, is sufficiently low (according to a system's specified accuracy).

2:

p(Vᵢ>Th_{RS})≈l/L

i.e., approximately I out of the total L nodes can be found to generate a Robust Signature according to the above definition.

3: Both Robust Signature and Signature are generated for a certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the Signature generation can be found in U.S. Pat. Nos. 8,326,775 and 8,312,031, assigned to common assignee, which are hereby incorporated by reference for all the useful information they contain.

A Computational Core generation is a process of definition, selection, and tuning of the parameters of the cores for a certain realization in a specific system and application. The process is based on several design considerations, such as:

(a) The Cores should be designed so as to obtain maximal independence, i.e., the projection from a signal space should generate a maximal pair-wise distance between any two cores' projections into a high-dimensional space.

(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.

(c) The Cores should be optimally designed with regard to invariance to a set of signal distortions, of interest in relevant applications.

A detailed description of the Computational Core generation and the process for configuring such cores is discussed in more detail in the above referenced U.S. Pat. No. 8,655,801, the contents of which are hereby incorporated by reference.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for creating a profile for an entity, comprising:
crawling through at least one web source, wherein the crawling comprises identifying at least one multimedia content element (MMCE) associated with a search query in the at least one web source;
analyzing the at least one MMCE, wherein the analyzing further comprises generating at least one signature based on the at least one MMCE;
identifying, based on the generated at least one signature, an entity associated with the at least one MMCE;
determining at least one characteristic associated with the entity; and
generating a profile for the entity based on the at least one characteristic.

2. The method of claim 1, further comprising:
receiving a request to generate a profile, wherein the request includes the search query.

3. The method of claim 1, wherein the characteristics include at least one of: impressions, personal preferences, environmental variables, variables associated with the entity, positive or negative values, and themes that are common among the additional MMCEs and the identified MMCE, descriptive phrases.

4. The method of claim 1, further comprising:
generating at least one concept based on the generated at least one signature, wherein the entity is represented by one of the at least one concept.

5. The method of claim 4, wherein each concept is a collection of signatures and metadata representing the concept.

6. The method of claim 4, wherein the at least one concept is determined by querying a concept-based database using the at least one signature.

7. The method of claim 4, further comprising:
generating at least one tag, wherein each tag is a textual index term describing the concept, wherein the entity is identified based on the at least one tag.

8. The method of claim 1, wherein the at least one signature is robust to noise and distortion.

9. The method of claim 1, wherein each signature is generated by a signature generator system including a plurality of at least partially statistically independent computational cores, wherein the properties of each core are set independently of the properties of each other core.

10. A non-transitory computer readable medium having stored thereon instructions for causing one or more processing units to execute a process for creating a profile for an entity, the process comprising:
crawling through at least one web source, wherein the crawling comprises identifying at least one multimedia content element (MMCE) associated with a search query in the at least one web source;
analyzing the at least one MMCE, wherein the analyzing further comprises generating at least one signature based on the at least one MMCE;
identifying, based on the generated at least one signature, an entity associated with the at least one MMCE;
determining at least one characteristic associated with the entity; and
generating a profile for the entity based on the at least one characteristic.

11. A system for generation of a profile for an entity, comprising:
a processing circuitry; and
a memory, the memory containing instructions that, when executed by the processing circuitry, configure the system to:
crawl through at least one web source, wherein the crawling comprises identifying at least one multimedia content element (MMCE) associated with a search query in the at least one web source;
analyze the at least one MMCE, wherein the analyzing further comprises generating at least one signature based on the at least one MMCE;
identify, based on the generated at least one signature, an entity associated with the at least one MMCE;
determine at least one characteristic associated with the entity; and
generate a profile for the entity based on the at least one characteristic.

12. The system of claim 11, further comprising:
receive a request to generate a profile, wherein the request includes the search query.

13. The system of claim 11, wherein the characteristics include at least one of: impressions, personal preferences, environmental variables, variables associated with the entity, positive or negative values, and themes that are common among the additional MMCEs and the identified MMCE, descriptive phrases.

14. The system of claim 11, further comprising:
generate at least one concept based on the generated at least one signature, wherein the entity is represented by one of the at least one concept.

15. The system of claim 14, wherein each concept is a collection of signatures and metadata representing the concept.

16. The system of claim 14, wherein the at least one concept is determined by querying a concept-based database using the at least one signature.

17. The system of claim 14, further comprising:
generate at least one tag, wherein each tag is a textual index term describing the concept, wherein the entity is identified based on the at least one tag.

18. The system of claim 11, wherein the at least one signature is robust to noise and distortion.

19. The system of claim 11, wherein each signature is generated by a signature generator system including a plurality of at least partially statistically independent computational cores, wherein the properties of each core are set independently of the properties of each other core.
